(19) United States
(12) Patent Application Publication
(10) Pub. No.: US 2005/0031760 A1
(43) Pub. Date: Feb. 10, 2005

(54) Barrel alternative for flavoring wine

(76) Inventor: David C. Plumb, Edina, MN (US)

Correspondence Address: BECK AND TYSVER, 2900 THOMAS AVENUE SOUTH, SUITE 100, MINNEAPOLIS, MN, 55416, US

(21) Appl. No.: 10/941,534

(22) Filed: Sep. 15, 2004

Related U.S. Application Data
(63) Continuation-in-part of application No. 10/360,983, filed on Feb. 8, 2003.

(51) Int. Cl. C12G 1/00

(52) U.S. Cl. 426/592

(57) ABSTRACT

A barrel alternative is a wood member cut or formed to expose a significant amount of longitudinal surface area in relation to the volume or length of the wood member. Because the longitudinal face is more permeable than other faces of the wood, extraction time is reduced and the barrel alternative can be produced in a cost effective manner.

This application is a continuation-in-part of, and claims priority to, U.S. Ser. No. 10/360,983 filed Feb. 8, 2003.

### FIELD OF THE INVENTION

The present invention relates generally to a device and method for flavoring wine, sparkling wine and other beverages. More particularly, the present invention relates to a natural wood barrel alternative, for placement in a barrel, tank or other container holding a beverage, sized and shaped for optimal and controlled exchange of wood flavoring with the beverage and a method of flavoring beverages with a natural wood insert.

### BACKGROUND OF THE INVENTION

Traditionally, many kinds of wine have been aged in barrels made of oak staves to impart oak flavor to the wine. As the wine resides in the barrel, the wine penetrates the wood and the flavor of the oak is extracted into the wine. The use of oak barrels for flavoring wine is, however, expensive due to the amount of wood required and due to the specialized skills and equipment required for barrel making. An oak barrel costs roughly $600-700 and can be filled only three to five times before the oak flavoring is exhausted or too mild to be practical. Thus, the barrel itself adds about $7 to the retail price of a bottle of wine.

To avoid the expense of oak barrels, alternative devices and methods have been developed to impart the flavor of oak to wine and other beverages. One such alternative is to suspend or float one or more pieces of wood in a barrel, such as where the barrel is “neutral”, i.e. is no longer able to impart flavor due to prior extraction. For example, Hojnoski, U.S. Pat. No. 4,558,639 teaches a wood insert for a container used for aging wine. Another way to avoid the expense of oak barrels is to use a container made of something other than oak. Stainless steel offers advantages though it cannot, of course, flavor the wine, and therefore wood inserts may be suspended or floated in the container to impart flavor.

Extracting flavor from oak takes time. The amount of time it takes is dependent, in part, on the amount and quality of the surface area of the wood to which the wine is exposed. Reducing the time it takes to impart the desired amount of oak flavoring is advantageous for wine makers. Thus, barrel alternatives have sought to provide a significant amount of surface area to speed extraction time. Prior barrel alternatives have not, however, accomplished an optimal balance between reduced extraction time and use of raw materials because they have not used wood sawn in an optimal manner. While many barrel alternatives are designed to yield a fair amount of surface area, no prior barrel alternative has been designed to maximize the most absorbent type of surface area in wood.

The significance of the quality or type of surface area to which the wine is exposed can best be understood by considering the anatomy of a tree from which wood is sawn. The vascular system of a tree enables water to be transported from the roots of the tree to its branches through the trunk in a direction largely parallel to the longitudinal axis of the trunk. To accomplish this, the cells of the trunk are generally configured to act as tiny pipelines for liquid moving in the axial direction. The cell structure in the trunk does not facilitate liquid flow in the radial direction through a tree trunk to the same degree that it facilitates flow in the axial direction. Thus, a cut surface that is perpendicular to the axis of the tree trunk is eight times more permeable than a surface parallel to the axis of the tree trunk. As a result, liquid flows much more easily in the axial direction than in the radial direction or other non-axial directions.

The conventional method that sawmills use to produce wood staves from a tree trunk is to cut members that are elongate in the same direction as the axis of the trunk. The resulting boards have very little surface area that is perpendicular to the axis of the trunk. Thus, when such boards are used as barrel alternatives, they provide relatively slow extraction of oak flavoring, since the liquid beverage largely contacts and enters the wood, and therefore must be absorbed, in a direction perpendicular to the axis of the trunk of the tree from which the board was sawn.

What has been needed is a barrel alternative that has a relatively high rate of extraction, while at the same time being sized and shaped for economical production and convenient use. Further, what has been needed is method of controlled, calibrated extraction.

### SUMMARY OF THE INVENTION

The present invention provides a barrel alternative configured to take advantage of the properties of wood that result from its role in a tree's vascular system. A barrel alternative according to the present invention is a wood member that has a substantial amount of surface area exposing the grain of the wood, such that there is a substantial area for a liquid to enter the natural vascular structure, thereby providing relatively speedy extraction of the oak flavor into the wood.

An object of the present invention is to lower the cost of oak flavoring by exposing a significant amount of the highly permeable cut surface that extends perpendicular to the axis of the tree from which the wood is sawn, without requiring a large wood member.

Another object of the present invention is to eliminate oak contamination and flavor taint as can result from re-use of wetted oak by providing a barrel alternative that is so economical it can be cost-effectively used just once.

Yet another object of the present invention is to provide a barrel alternative that can be sized and configured to be used easily in a wide variety of wine production containers.

Still another object of the present invention is to flavor a beverage using a barrel alternative in an expeditious, controlled manner.

These and other objects and advantages will be apparent from the detailed description below in conjunction with the accompanying drawings.

### BRIEF DESCRIPTION OF THE DRAWINGS

An exemplary version of a barrel alternative is shown in the figures wherein like reference numerals refer to equivalent structure throughout, and wherein:

FIG. 1 is perspective view of a squared log, illustrating a board, indicated by dotted lines, as it would be cut from the log using a typical commercial cutting method;

FIG. 2 is a perspective view of the board of FIG. 1;

FIG. 3 is a perspective view of the board of FIG. 1 rotated from the view of FIG. 2;

FIG. 4 is a perspective view of a first embodiment of a barrel alternative according to the present invention;

FIG. 5 is a perspective view of a second embodiment of a barrel alternative according to the present invention;

FIG. 6 is a perspective view of a third embodiment of a barrel alternative according to the present invention;

FIG. 7 is a perspective view of a fourth embodiment of a barrel alternative according to the present invention;

FIG. 8 is a perspective view of a fifth embodiment of a barrel alternative according to the present invention;

FIG. 9 is a perspective view of a squared log from which is cut a sixth embodiment of a barrel alternative, depicted by dotted lines, according to the present invention;

FIG. 10 is a diagram showing calibrated extraction times for the barrel alternative of FIG. 5, given various distances between cuts.

### DETAILED DESCRIPTION OF PREFERRED EMBODIMENT(S)

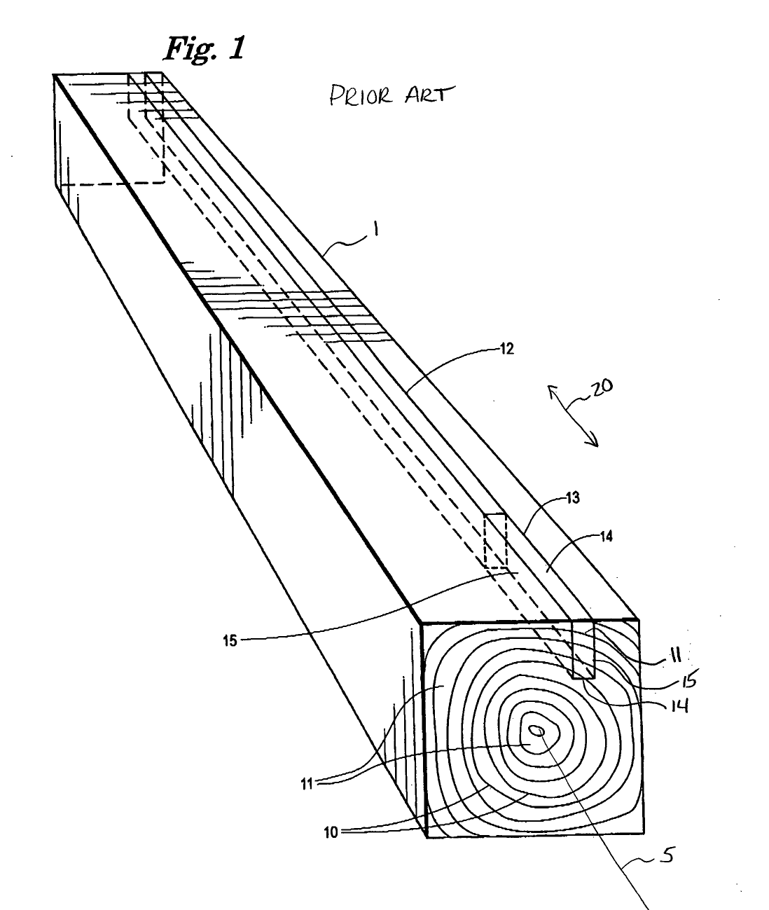

FIG. 1 depicts a squared log 1 having a longitudinal axis 5. A board or piece of lumber 12 is shown in dashed lines to illustrate how it would be cut from the log 1 according to typical commercial cutting methods. A section of the board 12 is indicated by reference number 13 and indicates a stave section to be cut from the board 12.

The following definitions will be used throughout and are illustrated with respect to a squared log 1 in FIG. 1:

“Longitudinal face” shall mean a cut face of wood that extends perpendicular to the direction of the axis of the tree trunk from which the wood is sawn. The annular rings of the tree are visible on this face. With reference to its orientation to a standing tree, the longitudinal face plane is horizontal. The longitudinal face of log 1, and the coinciding longitudinal face of board 12 and stave section 13, is indicated by reference number 11.

“Radial faces” and “tangential faces” shall mean the faces of the board 12 or stave section 13 that are perpendicular to the longitudinal face. The radial and tangential faces are perpendicular to one another. With reference to their orientation in a standing tree, the radial and tangential faces are vertical. In FIG. 1, the radial faces are denoted with reference number 14 and the tangential faces are denoted with reference number 15.

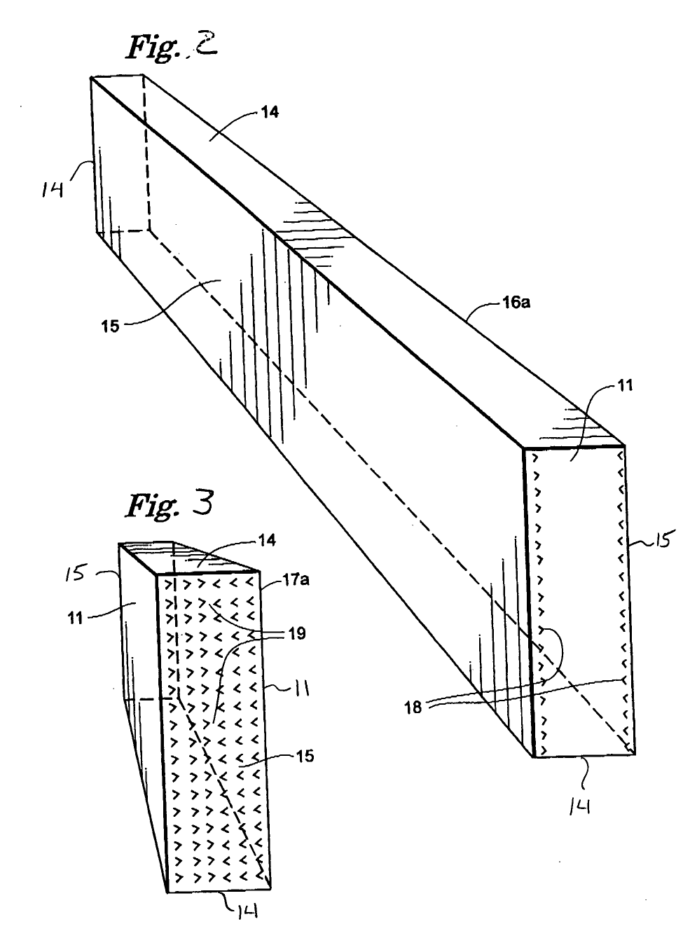

As discussed above in the Background section, the vascular system of the tree from which log 1 is squared provides for channeling liquid in the direction indicated by arrow 20. Thus, if stave section 13 were immersed in a liquid, the rates at which liquid would be absorbed through the faces would differ. Specifically, face 11 will absorb liquid much more quickly than radial faces 14 or tangential faces 15. This distinction in the varying absorption characteristics of the faces 11, 14, 15 is depicted in FIGS. 2 and 3. Arrows 18 schematically illustrate the relatively small amount of absorption that would take place through faces 15 in a given time period; in FIG. 3, arrows 19 indicate the relatively large amount of absorption that would take place through longitudinal face 11 in the same time period.

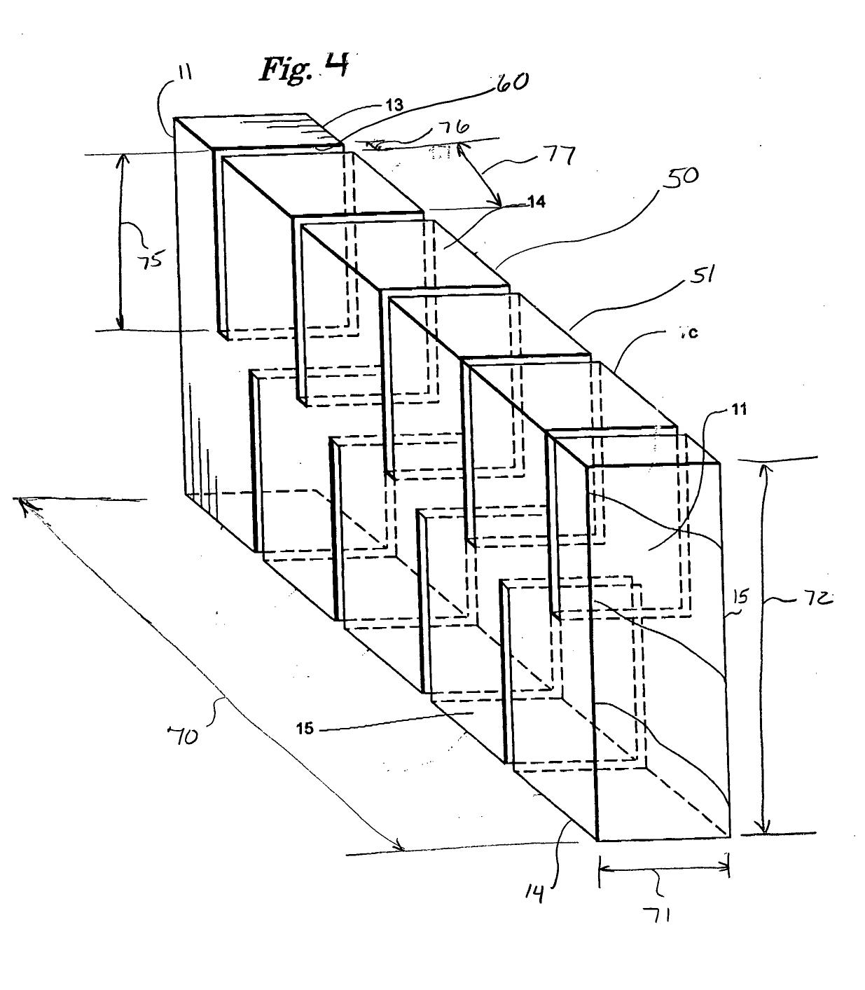

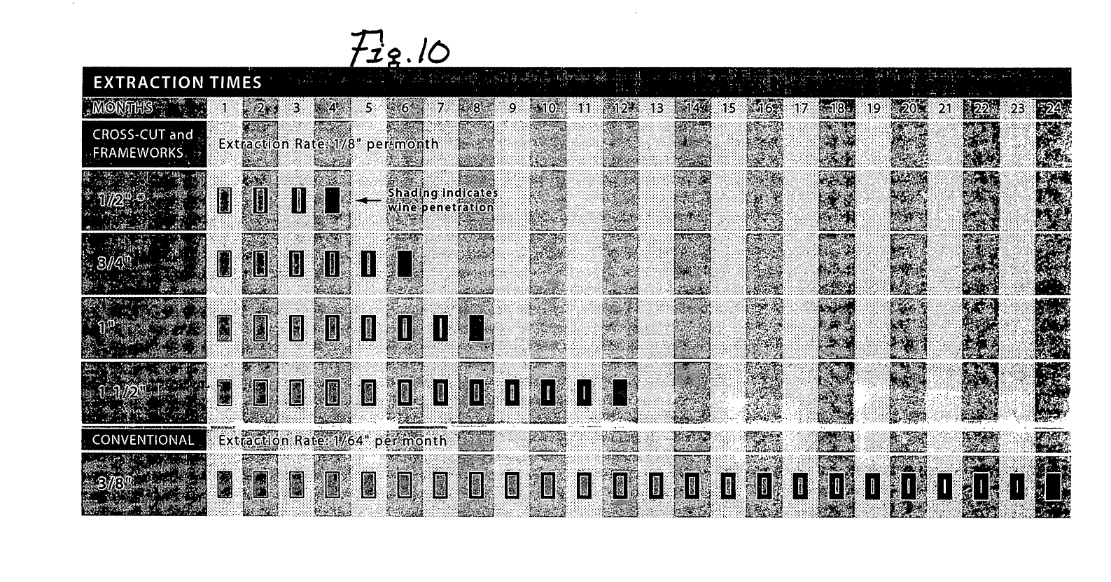

FIGS. 4-9 illustrate various embodiments of a barrel alternative that provide significant amounts of surface area on longitudinal planes. In other words, these barrel alternatives expose a significant amount of the most permeable surfaces of a piece of wood and thereby provide relatively rapid absorption of liquid and hence relatively fast extraction of oak flavoring. FIGS. 4-8 illustrate a barrel alternative made from a ripped stave section cut according to typical commercial cutting methods; FIG. 9 shows a barrel alternative made by an alternative method of cutting stave sections from a log.

FIG. 4 shows a first embodiment of a barrel alternative 50. The barrel alternative 50 is a wood member 51 having faces of three types: longitudinal faces 11, radial faces 14 and tangential faces 15. To provide a significant amount of longitudinal face surface, the wood member 51 is cross-cut at several locations. A representative cross-cut is given by reference number 60. In the FIG. 4 embodiment, cross-cuts 60 extend into the wood member 51 from opposite radial faces 14. The cuts in one radial face are offset from the cuts in the opposite radial face.

Various dimensions are depicted in FIG. 4 as follows:

Reference number 70 depicts the length of the wood member 51.

Reference number 71 depicts the width of the wood member 51.

Reference number 72 depicts the height of the wood member 51.

Reference number 75 depicts the depth of the cuts 60 from a radial face 14.

Reference number 76 depicts the width or “kerf” of the cuts 60.

Reference number 77 depicts the distance between adjacent cuts 60 along one radial face 14.

The dimensions of wood member 51 and the number, spacing, and dimensions of cross-cuts 60 defined therein may vary considerably within the scope of this invention, provided the barrel alternative 50 provides a significant amount of longitudinal surface area in comparison to the size of the wood member 51. In a preferred embodiment, the barrel alternative 50 will have longitudinal surface area that is at least 23% of the total surface area.

The following table provides dimensions for one example of a barrel alternative that provides longitudinal surface area that is at least 23% of the total surface area.

TABLE A

| Dimension | Example | |
|---|---|---|
| Length | 12.5 | in |
| Width | 1 1/16 | in |
| Height | 1 7/16 | in |
| Cut depth | 7/16 | in |
| Cut width | ⅛ | in |

| | |
|---|---|
| Number of cuts | 32 (at ½ inch intervals) |
| Calculated amount of | 40.32 square inches (from cuts) plus 3.05 |
| longitudinal surface area | square inches (from end faces) = 43.37 |
| given above dimensions | square in |
| Total surface area | 101.37 square inches |
| Ratio of longitudinal | 43% |
| surface area to total | |
| surface area | |
| (expressed as a percentage) | |

The following table provides dimensions for a second example having fewer cuts:

TABLE B

| Dimension | Example | |
|---|---|---|
| Length | 12.5 | in |
| Width | 1 1/16 | in |
| Height | 1 7/16 | in |
| Cut depth | 7/16 | in |
| Cut width | ⅛ | in |

| | |
|---|---|
| Number of cuts | 24 (at ¾ inch intervals) |
| Calculated amount of | 30.19 square inches (from cuts) plus 3.05 |
| longitudinal surface area | square inches (from end faces) = 33.24 |
| given above dimensions | square in |
| Total surface area | 94.24 square inches |
| Ratio of longitudinal surface | 35% |
| area to total surface area | |
| (expressed as a percentage) | |

The following table provides dimensions for a third examples having still fewer cuts:

TABLE C

| Dimension | Example | |
|---|---|---|
| Length | 12.5 | in |
| Width | 1 1/16 | in |
| Height | 1 7/16 | in |
| Cut depth | 7/16 | in |
| Cut width | ⅛ | in |

| | |
|---|---|
| Number of cuts | 18 (at 1 inch intervals) |
| Calculated amount of | 22.68 square inches (from cuts) plus 3.05 |
| longitudinal surface area | square inches (from end faces) = 25.73 |
| given above dimensions | square in |
| Total surface area | 87.73 square inches |
| Ratio of longitudinal surface | 29% |
| area to total surface area | |
| (expressed as a percentage) | |

The following table provides dimensions for a third examples having still fewer cuts:

TABLE D

| Dimension | Example | |
|---|---|---|
| Length | 12.5 | in |
| Width | 1 1/16 | in |
| Height | 1 7/16 | in |
| Cut depth | 7/16 | in |
| Cut width | ⅛ | in |

| | |
|---|---|
| Number of cuts | 12 (at 1 ½ inch intervals) |
| Calculated amount of | 15.12 square inches (from cuts) plus 3.05 |
| longitudinal surface area | square inches (from end faces) = 18.17 |
| given above dimensions | square in |
| Total surface area | 87.73 square inches |
| Ratio of longitudinal surface | 23% |
| area to total surface area | |
| (expressed as a percentage) | |

These tables present examples of dimensions that meet the design parameter of achieving longitudinal surface area that is at least 23% of the total surface area. Many other dimensions can be used to meet these design parameters and would be within the scope of this invention. A number of other parameters may be taken into account to optimize a barrel alternative and the examples given above satisfy these additional design parameters:
a provide large amount of longitudinal surface area;
keep volume low so that barrel alternative does not take up so much space in the barrel as to displace a significant amount of wine;
keep length low so that barrel alternative will fit in smaller size barrels;
keep number of cuts low, since cuts add to the time to produce a barrel alternative;
keep cut depth and number of cuts low enough to preserve strength of wood member 51 and to have an adequate amount of wood to provide desired flavoring;
The amount of longitudinal surface area can be controlled (and selected to match a desired extraction time) through changing the number of cuts and/or the depth of the cuts. Calibration of extraction time and exposed surface area will be discussed below.

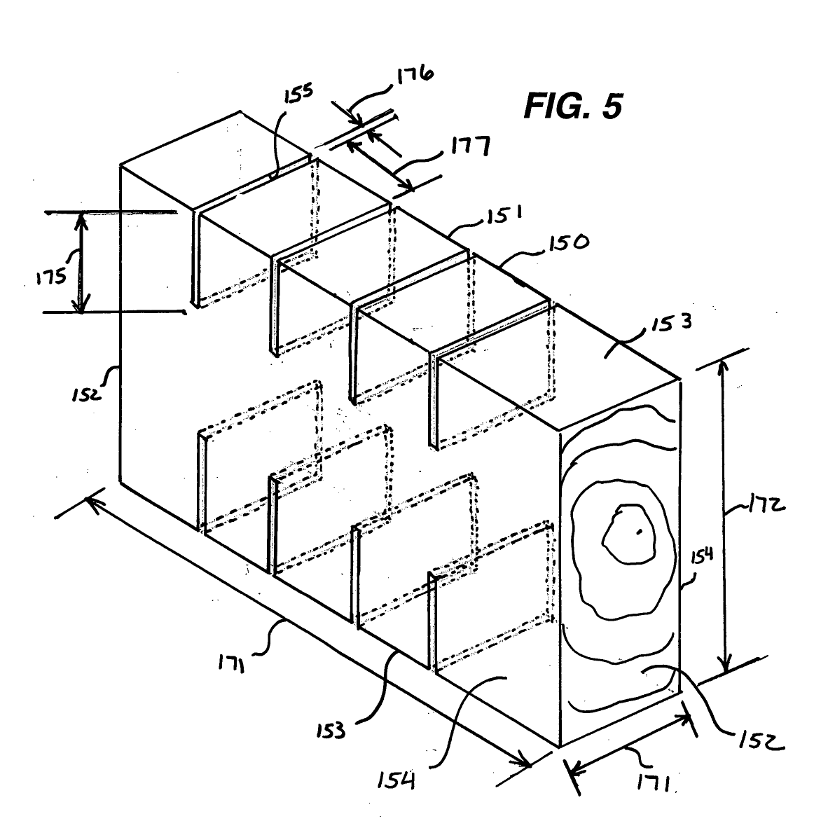

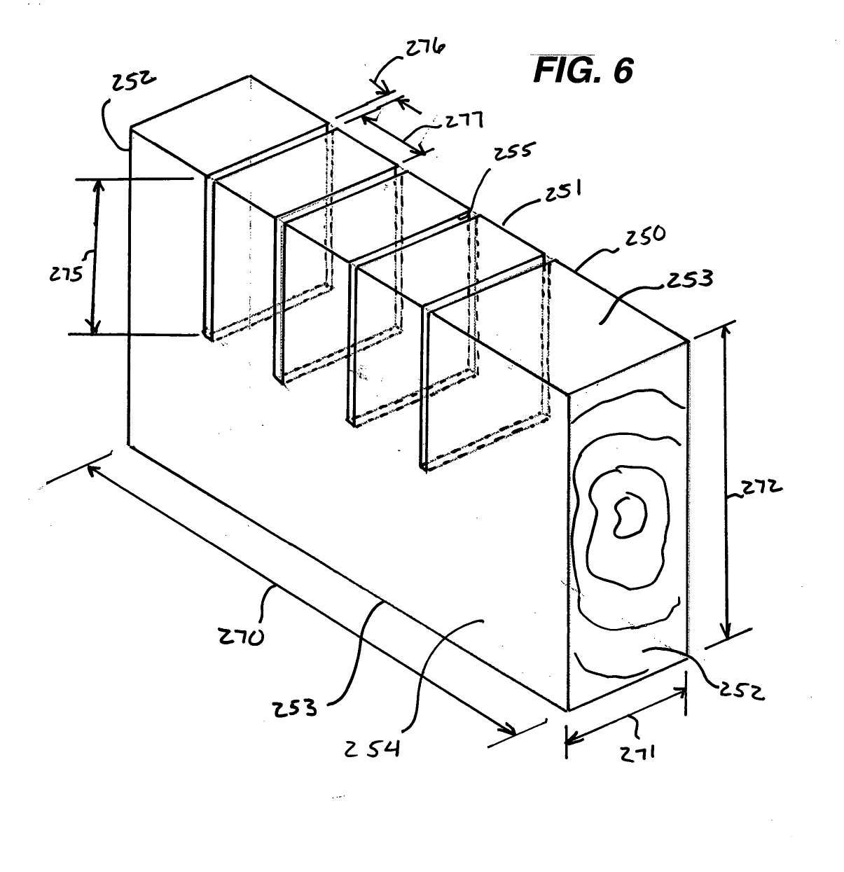

FIG. 5 shows another embodiment of a barrel alternative 150, formed of a wood member 151 having longitudinal faces 152, radial faces 153 and tangential faces 154. Barrel alternative 150 is similar to the embodiment of FIG. 4, except that the cuts (a representative one of which is indicated by reference number 155) that extend from the opposite radial faces 153 are aligned rather than offset. As with the FIG. 4 embodiment, the cuts 155 expose a significant amount of longitudinal surface area that is parallel to the longitudinal face 152. Various dimensions are depicted in FIG. 5 as follows:

Reference number 170 depicts the length of the wood member 151.

Reference number 171 depicts the width of the wood member 151.

Reference number 172 depicts the height of the wood member 151.

Reference number 175 depicts the depth of the cuts 60 from a radial face 153.

Reference number 176 depicts the width or “kerf” of the cuts 155.

Reference number 177 depicts the distance between adjacent cuts 155 along one radial face 153.

FIG. 6 shows yet another embodiment of a barrel alternative 250, formed of a wood member 251 having longitudinal faces 252, radial faces 253 and tangential faces 254. Barrel alternative 250 is similar to that of FIGS. 4 and 5, except that the cuts (a representative one of which is indicated by reference number 255) extend from only one of the radial faces 253. Because the cuts 255 extend from only one face, the cuts 255 can be made deeper in the dimension indicated by reference number 260 than those of FIGS. 4 and 5, while maintaining the strength of the wood member 251. Various dimensions are depicted in FIG. 6 as follows:

Reference number 270 depicts the length of the wood member 251.

Reference number 271 depicts the width of the wood member 251.

Reference number 272 depicts the height of the wood member 251.

Reference number 275 depicts the depth of the cuts 60 from a radial face 253.

Reference number 276 depicts the width or “kerf” of the cuts 255.

Reference number 277 depicts the distance between adjacent cuts 255 along one radial face 253.

In the embodiments of FIGS. 4-7, the cuts 60, 155, 255, 355 are made generally parallel to the respective longitudinal faces 11, 152, 252, 352 of respective wood members 51, 151, 251, 351.

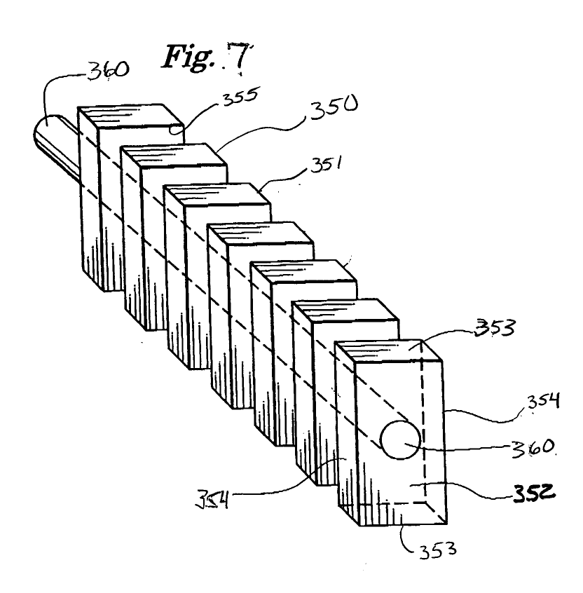

FIG. 7 shows still another embodiment of a barrel alternative 350, formed of a wood member 351 having longitudinal faces 352, radial faces 353 and tangential faces 354. This embodiment may be formed by turning the wood member 351 on a lathe and removing wood down to a central axial core 360 at intervals along the length of the wood member. The cuts, a representative one of which is depicted by reference number 355, formed by the removal of wood at intervals expose significant amounts of longitudinal surface area parallel to the longitudinal face 352 of the wood member 351.

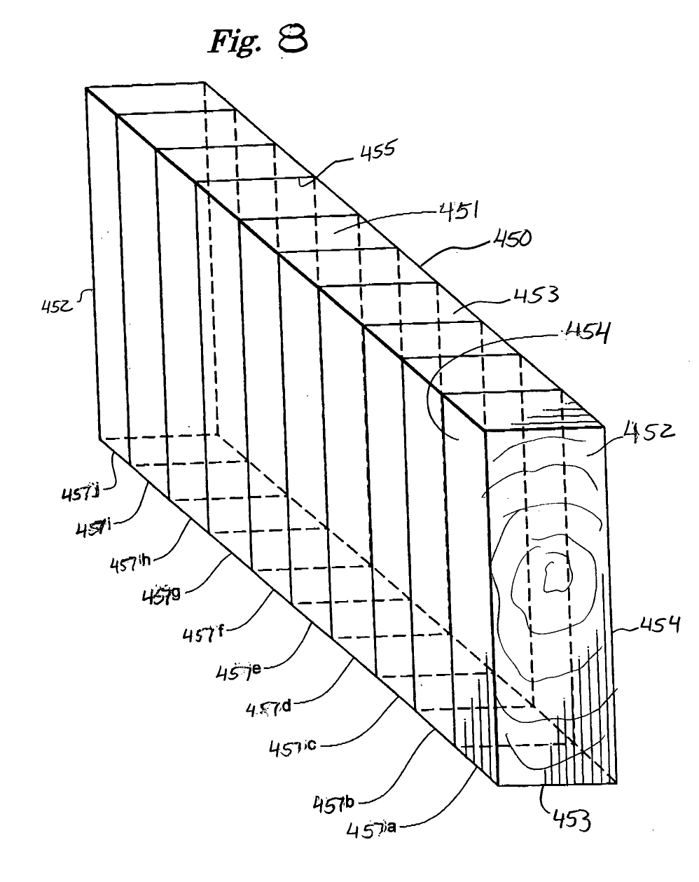

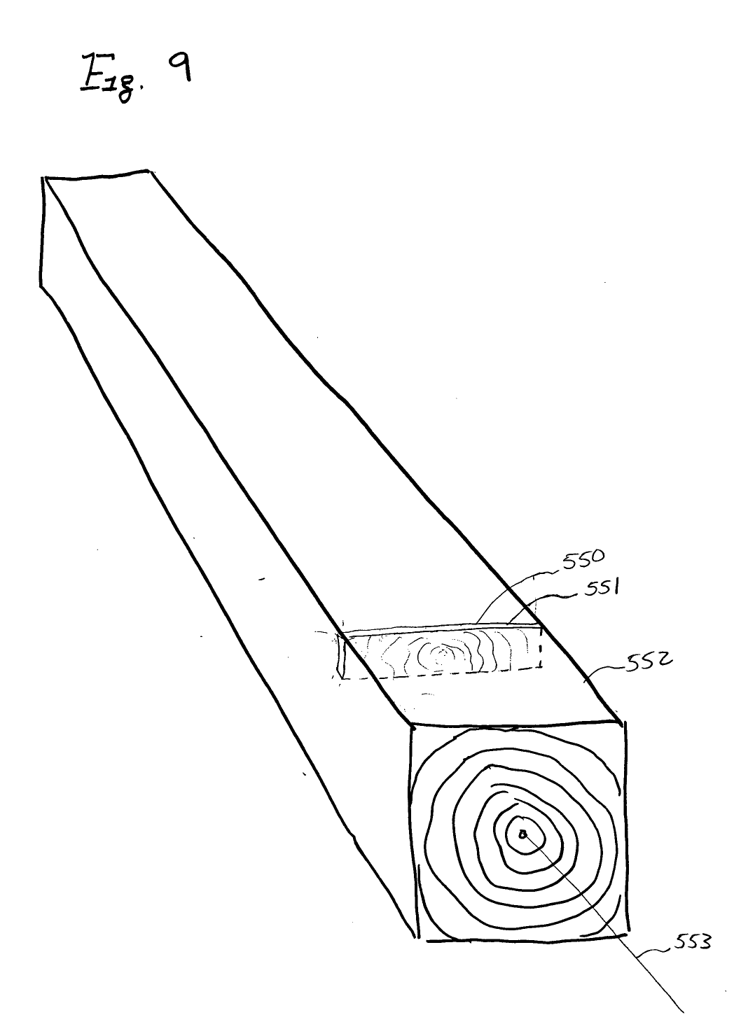

FIG. 8 illustrates yet another embodiment of a barrel alternative 450, formed of a wood member 451 having longitudinal faces 452, radial faces 453 and tangential faces 454. The wood member 451 is sliced by making cuts (a representative one of which is indicated by reference number 455) parallel to the longitudinal faces 452 all the way through the wood member 451, yielding slices 457a-j. The slices may tend to stick to one another when floating in or suspended in a beverage-filled barrel; therefore, spaces, such as a lip or peg, may be added to the faces of the slices to keep them from abutting and to thereby maintain their full surface area so that extraction time is maximized and is known.

FIG. 9 illustrates still another embodiment of a barrel alternative 550, formed of a wood member 551. This wood member 551 differs from those of FIGS. 4-8 because it is originally cross-cut from a log 552 (i.e. by slicing through the log in the direction perpendicular to the tree trunk's axis 553), rather than being cut in the traditional commercial manner illustrated in FIG. 1. The resulting cross-cut wood member 551 has a significant amount of longitudinal surface area in relation to its length or to its volume, without the need to add additional cuts.

In operation, the barrel alternative 50, 150, 250, 350, 450, 550 is placed in a barrel with a beverage to be flavored. Over time, the beverage penetrates the wood and flavor (soluble chemical compounds) from the wood is extracted into the beverage. As noted briefly above, the specifics of the barrel alternative can be matched to the desired extraction time. If a speedier extraction time is desired, then a greater number of cuts would be used for the embodiments of FIGS. 4-8. Preferred distances between cuts are in the range of ⅜ inch to 3 inches. FIG. 10 is a calibration chart providing extraction times given various distances between cuts (and correspondingly various numbers of cuts per given length). The calibration chart of FIG. 10 reflects the performance of barrel alternatives 50 and 150 of the type illustrated in FIGS. 4 and 5 having the following dimensions:

TABLE E

| | | | | |
|---|---|---|---|---|
| Spacing of Cuts (inches) | ½ | ¾ | 1 | 1 ½ |
| Length (inches) | 12.5 | 12.5 | 12.5 | 12.5 |
| Width (inches) | 1 1/16 | 1 1/16 | 1 1/16 | 1 1/16 |
| Height (inches) | 1 7/16 | 1 7/16 | 1 7/16 | 1 7/16 |
| Cut depth (inches) | 7/16 | 7/16 | 7/16 | 7/16 |
| Cut width (inches) | ⅛ | ⅛ | ⅛ | ⅛ |
| Number of cuts | 32 | 24 | 18 | 12 |
| Calculated amount of longitudinal | 43.37 | 33.24 | 25.73 | 18.17 |
| surface area given above | | | | |
| dimensions (square inches) | | | | |
| Total surface area (square inches) | 101.37 | 94.24 | 87.73 | 87.73 |
| Ratio of longitudinal surface area | 43% | 35% | 29% | 23% |
| to total surface area (expressed as a | | | | |
| percentage) | | | | |

The last line of the chart of FIG. 10 represents the extraction rate that results from a ⅜ stave cut in the conventional manner without cuts to expose longitudinal surface area. This conventional stave has dimensions of 1″×18″⅜″.

Similar calibration charts can be generated for other embodiments and for any desired dimensions.

The preferred material for the barrel alternatives described herein is oak, and more particularly white oak that is toasted. Other materials may be used to achieve other desired flavors.

Although an illustrative version of the device is shown, it should be clear that many modifications to the device may be made without departing from the scope of the invention. For example, the cuts in the embodiments of FIGS. 4-6 might be made in the tangential face(s) rather than in the radial face(s).

1. A barrel alternative for flavoring a beverage in a container over time, comprising: a wood member having longitudinal surface area that is at least 23% of the total surface area of the wood member.

2. A barrel alternative according to claim 1, wherein said wood member is a generally elongate member extending lengthwise in a direction parallel to the trunk of the tree from which the member is sawn, and wherein said member is generally rectangular in transverse cross section, and said member defining a plurality of cuts extending transversely partially through said member thereby exposing longitudinal surface area in the natural grain of the wood.

3. A barrel alternative according to claim 2 wherein said cuts are defined in opposite sides of said member.

4. A barrel alternative according to claim 3, wherein cuts on opposite sides are offset from one another.

5. A barrel alternative according to claim 3, wherein cuts on opposite sides are aligned with one another.

6. A barrel alternative according to claim 2 wherein said cuts are defined in one side of said member.

7. A barrel alternative according to claim 2 wherein said adjacent cuts are spaced between about 0.5 inches and 1.5 inches apart.

8. A barrel alternative according to claim 2 wherein said adjacent cuts are about 0.5 inches apart.

9. A barrel alternative according to claim 2 wherein said adjacent cuts are about 1 inch apart.

10. A barrel alternative according to claim 1, wherein said wood member is generally elongate and extends lengthwise in a direction perpendicular to the trunk of the tree from which the member is sawn.

11. A barrel alternative according to claim 1, wherein the wood member is oak.

12. A barrel alternative according to claim 11, wherein the wood member is white oak.

13. A method of flavoring wine, comprising the steps of:
a) placing wine in a container;
b) placing a barrel alternative in the container in contact with the wine, said barrel alternative having a known amount of longitudinal surface area and a known amount of total surface area, with the longitudinal surface area being at least 23% of the total surface area.

14. A barrel alternative comprising a generally elongate wood member extending lengthwise in a direction parallel to the trunk of the tree from which the member is sawn, and wherein said member is generally rectangular in transverse cross section, and said member defining a plurality of cuts extending transversely partially through said member thereby exposing longitudinal surface area in the natural grain of the wood.
